(19) United States
(12) Patent Application Publication
(10) Pub. No.: US 2011/0012855 A1
(43) Pub. Date: Jan. 20, 2011

(54) METHOD AND DEVICE FOR PALM REJECTION

(75) Inventors: SHANG-TAI YEH, Taipei City (TW); Jia-Ming Chen, Taipei City (TW)

Correspondence Address: WPAT, PC;INTELLECTUAL PROPERTY ATTORNEYS, 7225 BEVERLY ST., ANNANDALE, VA, 22003, US

(73) Assignee: EGALAX_EMPIA TECHNOLOGY INC., Taipei City (TW)

(21) Appl. No.: 12/839,024

(22) Filed: Jul. 19, 2010

Related U.S. Application Data
(60) Provisional application No. 61/226,475, filed on Jul. 17, 2009.

(51) Int. Cl. G06F 3/041

(52) U.S. Cl. 345/173

(57) ABSTRACT

The present invention carries out palm rejection on a multi-touch panel. The panel is first touched by a palm before the detection of a finger or pen to define a rejection region and the touch location of the finger or pen is detected outside that rejection region. The present invention, when the rejection region and the touch location of the finger or pen have been detected, is able to continuously detecting a region touched by the palm using a detected range defined by the rejection region to determine whether the rejection region needs to be updated.

### FIELD OF THE INVENTION

The present invention relates to a multi-touch device and method, and more particularly, to multi-touch device and method for palm rejection.

### BACKGROUND OF THE INVENTION

U.S. Pat. No. 6,628,269 discloses a method for palm rejection. Compare to a traditional resistive touch device that uses a pair of conductive films facing each other, this patent utilizes two stacked pairs of two-layered conductive films facing each other. The top pair of conductive films is interposed by less densely arranged insulating spacers while the bottom pair of conductive films is interposed by more densely arranged insulating spacers. As a result, only a pointy touch can cause the conductive films of the bottom pair to contact each other, while a touch occupying a larger area (e.g. a palm touch) can only cause the conductive films of the top pair to contact each other, thus achieving palm rejection and obtaining the correct position of the pointy touch. However, such a design requires double the amount of conductive films, and thus a higher cost.

### SUMMARY OF THE INVENTION

One objective of the present invention is to carry out palm rejection on a multi-touch panel. The panel is first touched by a palm before the detection of a finger or pen to define a rejection region and the touch location of the finger or pen is detected outside that rejection region.

Another objective of the present invention is, when the rejection region and the touch location of the finger or pen have been detected, to continuously detecting a region touched by the palm using a detected range defined by the rejection region to determine whether the rejection region needs to be updated.

Therefore, the present invention requires only a set of touch device to carry out palm rejection without the need for two set of conductive film pairs required in the prior art described above.

The objectives and solutions of the technical problems are achieved by the technical means below. A method for palm rejection according to the present invention includes: scanning a touch panel to obtain an image; detecting at least one first touched region based on the image before the touch panel is touched by at least one finger or pen; defining at least one rejection region based on the first touched region when the at least one first touched area is detected; and identifying a touch location corresponding to each of the finger or pen outside the at least one rejection region when the touch panel is being touched by the at least one finger or pen. The objectives and solutions of the technical problems are also achieved by the technical means below. A touch device for palm rejection according to the present invention includes: a touch device for providing an image; and a controller for scanning the touch device for obtaining the image and performing at least the following processes: detecting at least one first touched region based on the image before the touch panel is touched by at least one finger or pen; defining at least one rejection region based on the first touched region when the at least one first touched area is detected; and identifying a touch location corresponding to each of the finger or pen outside the at least one rejection region when the touch panel is being touched by the at least one finger or pen.

The objectives and solutions of the technical problems are further achieved by the technical means below.

The above method or controller further includes: defining at least one detected range based on the at least one rejection region; detecting at least one second touched region in the at least one detected range; generating a difference region by comparing the at least one second touched region and the at least one touched region; determining whether a command for updating the at least one first touched region is generated based on the difference region; and detecting the at least one touched region outside the touch location corresponding to each finger or pen upon generation of the command for updating the at least one first touched region.

The said detected range is determined by expanding the at least one rejection region by a predetermined percentage.

The said first and second touched regions include at least one block, and only one touch location can be identified in a single block.

The said detection of the first and second touched regions is determined by whether a touch location is identified in each block.

### BRIEF DESCRIPTION OF THE DRAWINGS

The present invention can be more fully understood by reading the following detailed description of the preferred embodiments, with reference made to the accompanying drawings, wherein:

FIG. 1A is a flowchart illustrating an embodiment of the present invention;

FIG. 1B is a flowchart illustrating another embodiment of the present invention;

FIG. 2 is a schematic diagram depicting an image of the prior art;

FIG. 3 is a schematic diagram depicting an image of a palm touch according to the present invention;

FIG. 4 is a schematic diagram depicting an image of a palm touch and finger touches according to the present invention;

FIGS. 5 and 6 are schematic diagrams depicting images for rejection regions according to the present invention;

FIG. 7 is a schematic diagram depicting a difference region according to the present invention; and

FIG. 8 is a schematic diagram depicting re-detected touched regions according to the present invention.

### DETAILED DESCRIPTION OF THE EMBODIMENTS

The present invention is described by the following specific embodiments. However, the present invention can be broadly applied to embodiments other than those disclosed herein. The scope of present invention is not limited by these embodiments, rather, by the appended claims. For clarity and understanding of the present invention, various elements in the figures are not necessarily drawn to scale; the dimensions of some may be exaggerated relative to others, and some are not described in details.

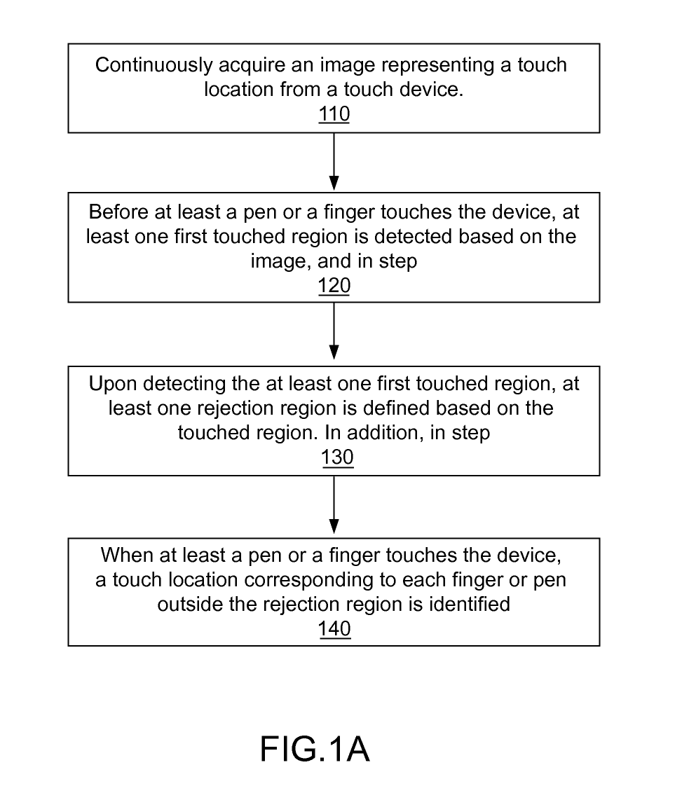

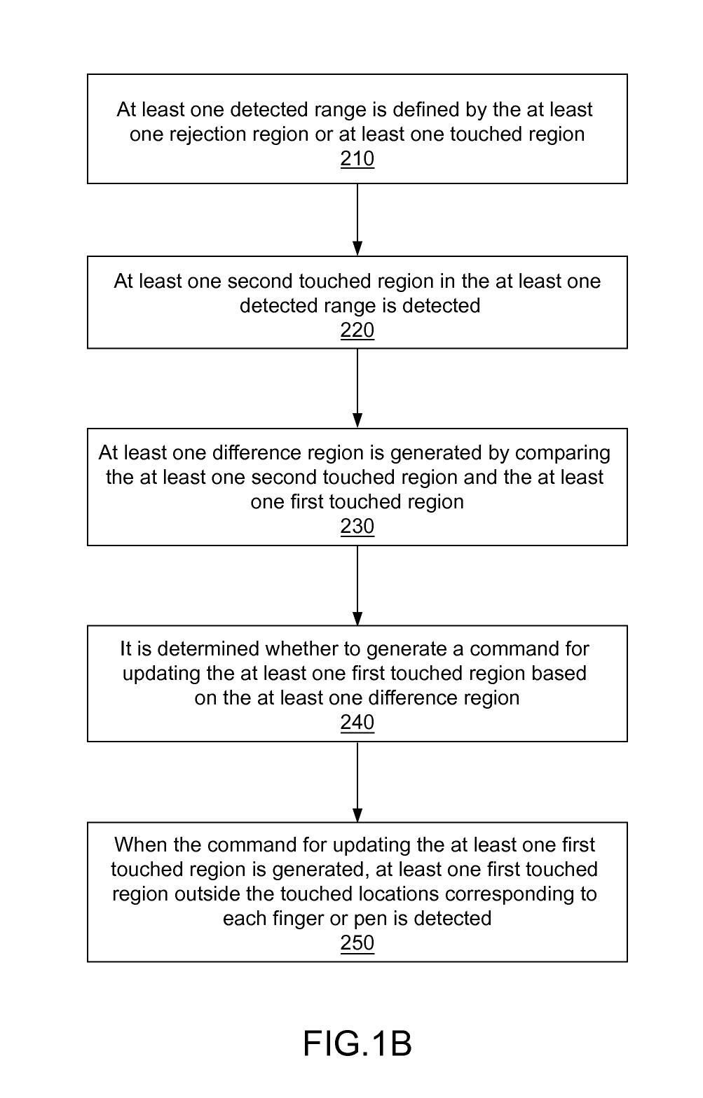

FIG. 1A is a flowchart illustrating a method for palm rejection according to an embodiment of the present invention. As shown in step 110, a touch device continuously acquires an image representing a touch location. In step 120, before at least a pen or a finger touches the device, at least one first touched region is detected based on the image, and in step 130, upon detecting the at least one first touched region, at least one rejection region is defined based on the touched region. In addition, in step 140, when at least a pen or a finger touches the device, a touch location corresponding to each finger or pen outside the rejection region is identified.

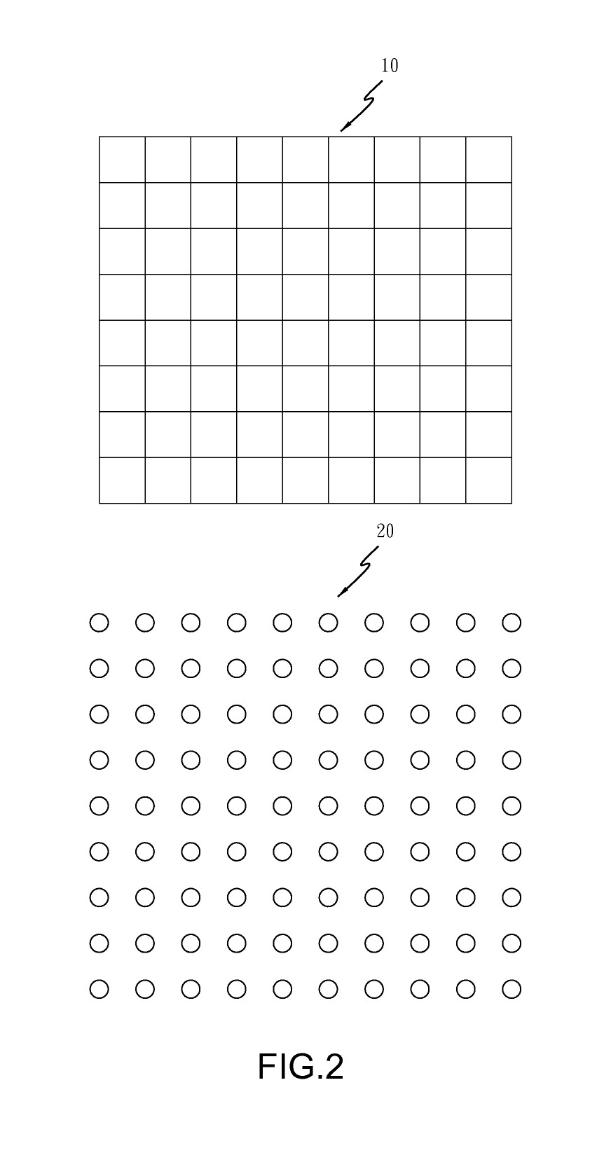

As shown in FIG. 2, the touch device 10 described above can be a capacitive touch device, a resistive touch device or any device that generates image 20 in the form of a matrix known to those with ordinary skills in the art. For example, in the projection-type capacitive touch device, the image 20 is an image resulted from the changes in capacitances on each location of the touch surface.

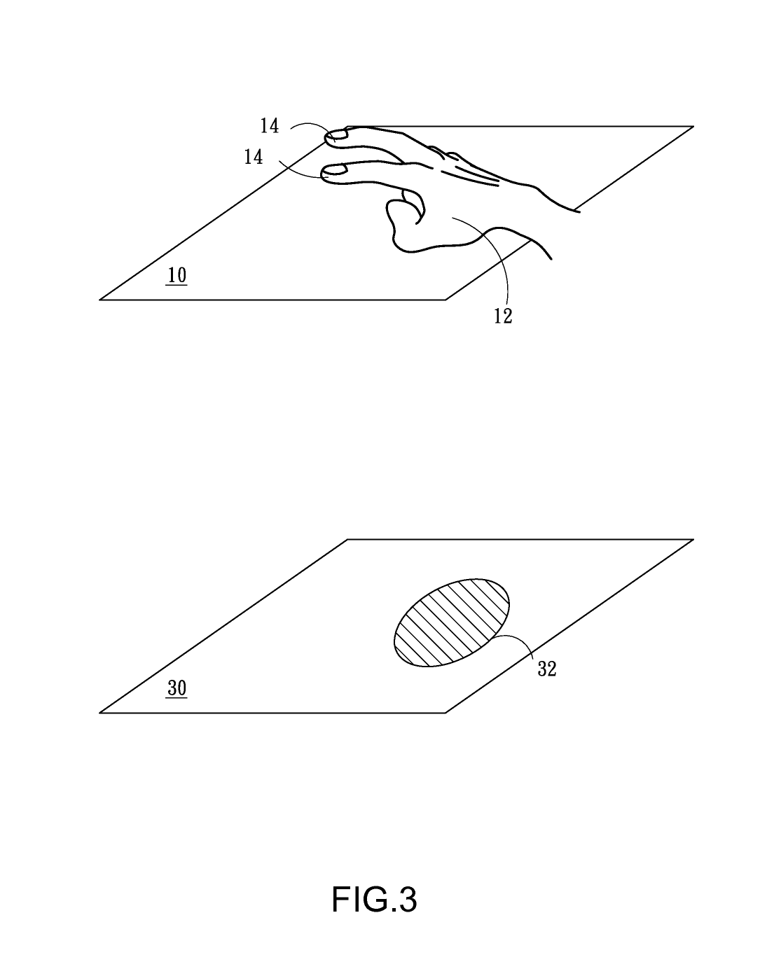

As shown in FIG. 3, in an example of the present invention, a palm 12 (except for a finger 14) must come near or touch the touch device 10 before the finger 14 or a pen does. Accordingly, when the palm 12 comes near or touches the touch device 10, at least one first touched range 32 can be acquired. In the image 30, the region operated by the palm 12 can be made up of one or more areas, while the touch range by the finger 14 or the pen consists of only a single area. Thus, based on the number of touched areas or coverage range, one can determine whether there is one or more palms 12 approaching or touching the device. For example, the touch range by the finger 14 or the pen can be preset in a predetermined range defined by a plurality of points or the number of points covered. When an area is outside the predetermined range, one can determine that at least a palm 12 is touching/approaching the touch device 10. Moreover, in another example of the present invention, one can determine that at least a palm 12 is touching/approaching the touch device 10 when an image in an untouched state (e.g. the image 20 in FIG. 2) has turned into an image 30 in a touched state. The areas described above can be extracted from the image using image processing techniques know to one skilled in the art, and they will not be discussed in the present invention.

In addition, when it is determined that at least a palm 12 is touching/approaching the touch device 10, if there is no area smaller than the predetermined range being touched before, any area larger than the predetermined range is regarded as a palm touch. Thus, the time period before a finger 14 touches the device can also be identified to detect the at least one first touched range 32.

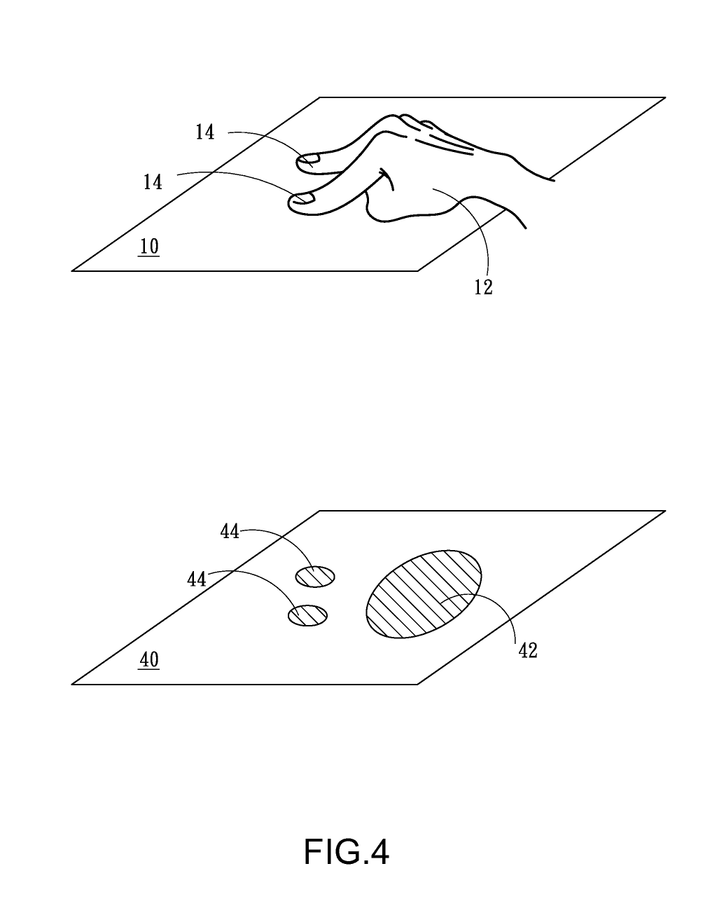

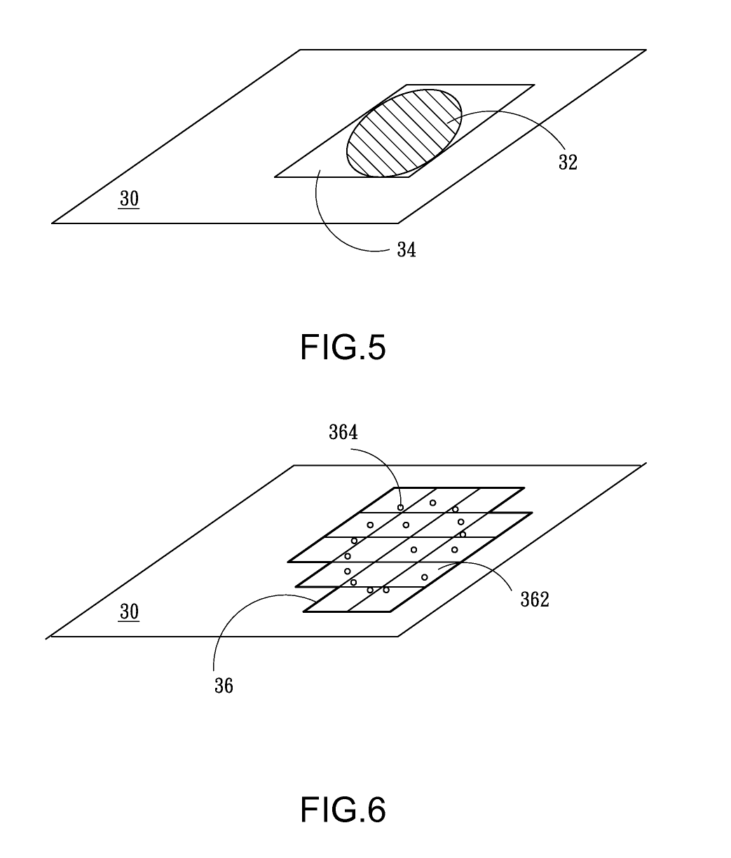

When the at least one first touched region 32 is detected, it can immediately be defined as the at least one rejection region 42 described above, as shown by an image 40 in FIG. 4. Alternatively, as shown in FIG. 5, an at least one rejection region 34 covering each first touched region 32 can also be defined based on each touched region. For example, when a single palm 12 touches the device, a rejection region 34 covering all regions touched by the palm is defined, or when a plurality of palms 12 touch the device, a plurality of rejection regions 34 covering the plurality of regions touched by the palms are defined. Thus, when at least a finger or a pen touches a place outside the at least one rejection region 34, as shown in FIG. 6, a touch location corresponding to each finger or pen outside the at least one rejection region 34 can be identified.

In a preferred mode of the present invention, as shown in FIG. 6, an image covers a plurality of blocks 362, each block 362 includes a plurality of points, but only one point 364 in a block will be detected. Thus, the first touched region or rejection region 36 may consist of touched points 364 or touched blocks 362. For example, a rejection region 36 covering the touched blocks can be easily identified based on the first touched range, or touched blocks 362 can be directly treated as the rejection regions 36, which has a better computation performance compared to defining rejection regions using touched points 364.

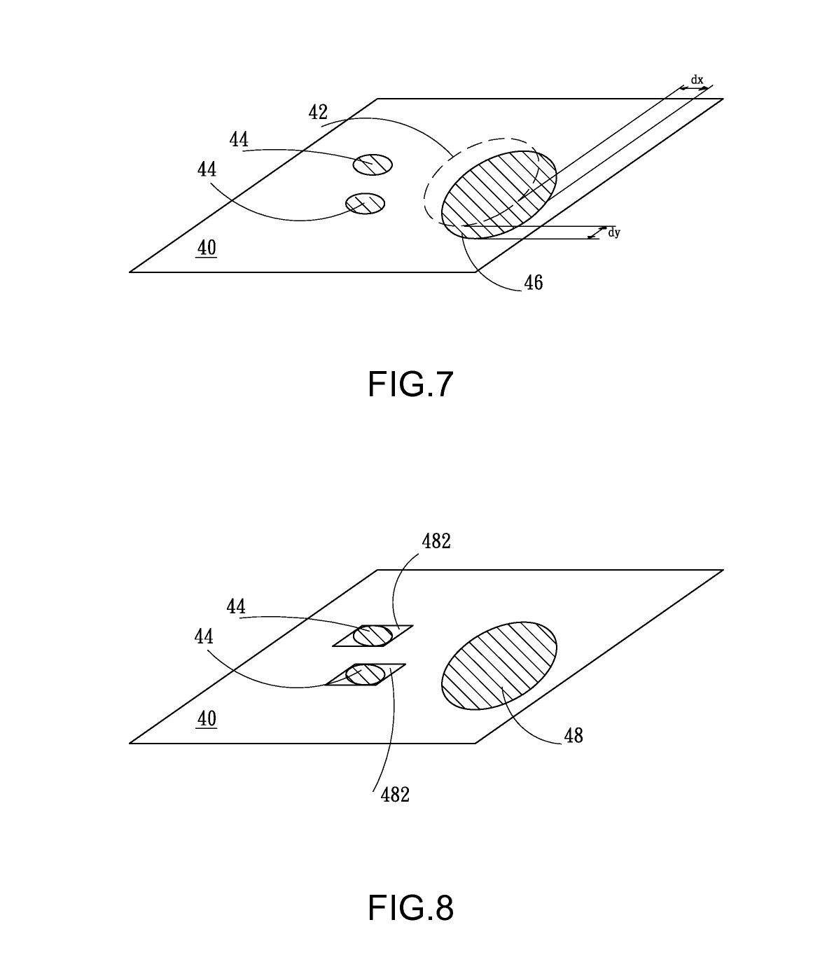

Another embodiment of the present invention further includes continuously adjusting the at least one first touched region when at least one finger or pen is touching the touch device, as shown in FIGS. 1B, 7 and 8. First, in step 210, at least one detected range is defined based on the at least one rejection region or at least one touched region. Then in step 220, at least one second touched region 42 in the at least one detected range is detected. In step 230, at least one difference region is generated by comparing the at least one second touched region 42 and an at least one first touched region 46. Thereafter, in step 240, it is determined whether to generate a command for updatingupdating the at least one first touched region 48 based on the at least one difference region. Then, as shown in step 250, when the command for updatingupdating the at least one first touched region 48 is generated, the at least one first touched region 48 outside the touched locations corresponding to each finger 44 or pen is detected.

In an example of the present invention, the first and second touched regions include at least one block, and only one touched location can be identified from a single block. The detection of the first and second touched regions is determined by whether the first touched region identifies a touched location.

In an example of the present invention, each detected range can be defined by expanding each rejection range by a certain percentage, or using the entire or a portion of the image. Regardless of the detected range, the at least one second touched region described above can be a touched region outside the at least one rejection region and outside the touched locations corresponding to each finger or pen.

In an example of the present invention, the difference region can be points, blocks or an area not intersected by all the first touched regions and the second touched regions. When the points or the area in the difference region exceed a certain threshold, the command for updating the at least one first touched region is generated to detect the at least one first touched region again, and the at least one rejection region is generated as mentioned before. In another example of the present invention, the generation of the command for updating the at least one first touched region can be based on the at least one second touched region.

Another embodiment of the present invention is a touch device for palm rejection including a touch device and a controller. The touch device provides an image representing touched locations. The controller can be a processor, ASIC, or any programmable calculators or apparatus. For example, the controller can include or combine a storage medium (e.g. a memory or a disk), if a program in the storage medium is executed, it will cause the following processes to be performed: before at least one finger or pen touches the device, at least one first touched region is detected based on the image; when the at least one first touched region is detected, at least one rejection region is defined based on the first touched region; and when at least one finger or pen touches the device, a touch location corresponding to each finger or pen outside the at least one rejection region is identified.

Moreover, while at least the finger or pen touches the device, the processor performs the following processes: at least one detected range is defined by the at least one rejection region or at least one touched region; at least one second touched region in the at least one detected range is detected; at least one difference region is generated by comparing the at least one second touched region and the at least one first touched region; it is determined whether to generate a command for updating the at least one first touched region based on the at least one difference region; and when the command for updating the at least one first touched region is generated, at least one first touched region outside the touched locations corresponding to each finger or pen is detected. Finally, a new location of a finger 482 or pen outside the at least one first touched region 48 is detected.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A method for palm rejection, comprising:
scanning a touch panel to obtain an image;
detecting at least one first touched region based on the image before the touch panel is touched by at least one finger or pen;
defining at least one rejection region based on the first touched region when the at least one first touched region is detected; and
identifying a touch location corresponding to each of the finger or pen outside the at least one rejection region when the touch panel is being touched by the at least one finger or pen.

2. The method for palm rejection of claim 1, further comprising:
defining at least one detected range based on the at least one rejection region;
detecting at least one second touched region in the at least one detected range;
generating a difference region by comparing the at least one second touched region and the at least one touched region;
determining whether a command for updating the at least one first touched region is generated based on the difference region; and
detecting the at least one touched region outside the touch location corresponding to each finger or pen upon generation of the command for updating the at least one first touched region again.

3. The method for palm rejection of claim 2, wherein the detected range is determined by expanding the at least one rejection region by a predetermined percentage.

4. The method for palm rejection of claim 1, wherein the first and second touched regions include at least one block, and only one touch location can be identified in a single block.

5. The method for palm rejection of claim 1, wherein the detection of the first and second touched regions is determined by whether a touch location is identified in each block.

6. A touch device for palm rejection, comprising:
a touch device for providing an image; and
a controller for scanning the touch device for obtaining the image and performing at least the following processes:
detecting at least one first touched region based on the image before the touch panel is touched by at least one finger or pen;
defining at least one rejection region based on the first touched region when the at least one first touched region is detected; and
identifying a touch location corresponding to each of the finger or pen outside the at least one rejection region when the touch panel is being touched by the at least one finger or pen.

7. The touch device for palm rejection of claim 6, further comprising at least the following processes:
defining at least one detected range based on the at least one rejection region;
detecting at least one second touched region in the at least one detected range;
generating a difference region by comparing the at least one second touched region and the at least one touched region;
determining whether a command for updating the at least one first touched region is generated based on the difference region; and
detecting the at least one touched region outside the touch location corresponding to each finger or pen upon generation of the command for updating the at least one first touched region.

8. The touch device for palm rejection of claim 7, wherein the detected range is determined by expanding the at least one rejection region by a predetermined percentage.

9. The touch device for palm rejection of claim 6, wherein the first and second touched regions include at least one block, and only one touch location can be identified in a single block.

10. The touch device for palm rejection of claim 6, wherein the detection of the first and second touched regions is determined by whether a touch location is identified in each block.
